(19) United States
(12) Patent Application Publication
(10) Pub. No.: US 2011/0262616 A1
(43) Pub. Date: Oct. 27, 2011

(54) FAT COMPOSITION

(75) Inventors: Shoji Matsumoto, Tokyo (JP); Takatoshi Yamashita, Tokyo (JP); Hiroshi Shiramasa, Tokyo (JP)

(73) Assignee: J-OIL MILLS INC., Tokyo (JP)

(21) Appl. No.: 13/141,708

(22) PCT Filed: Dec. 25, 2009
(86) PCT No.: PCT/JP2009/071659

§ 371 Date: Jun. 23, 2011

(30) Foreign Application Priority Data
Dec. 26, 2008 (JP) 2008-333651

(51) Int. Cl. A23D 7/01; A23D 9/013

(52) U.S. Cl. 426/611; 426/601

(57) ABSTRACT

There is provided a fat composition that makes possible to prepare stir-fried food, deep-fried food or mayonnaise. The fat composition contains an emulsifier having an HLB of not more than 5 in an amount of 0.1 to 3% by weight.

### TECHNICAL FIELD

The present invention relates to a novel fat composition that can produce delicious stir-fried food even at a reduced quantity of use and that is versatile to be used for deep frying, raw foods in the preparation of mayonnaise, and so forth.

### BACKGROUND ART

The following are ordinarily used as deep-frying fats: vegetable oils such as rapeseed oil, soybean oil, sesame oil, corn oil, safflower oil, sunflower oil, rice bran oil, palm oil, either individually or in combination, as well as processed fats provided by subjecting the preceding oils to, for example, hydrogenation, transesterification. Except when use is made of the flavor of a fat such as sesame oil or olive oil, these fats are used in the form of highly refined fats in order to make the best use of the flavor of the ingredients, and the best fat is used as dictated by the particular objectives.

A characteristic feature of deep frying is that cooking proceeds by the exchange of the deep-frying oil with the moisture fraction in the ingredients at high temperatures. When deep frying is carried out using a relatively fresh fat, good flavor is obtained due to a synergistic effect between the fat and the flavor of the ingredients. On the other hand, stickiness by the oil, a deterioration in food texture such as heartburn, a decline in flavor and nutritional value and so forth, is produced with a fat that has undergone deterioration due to long-term use. In addition, in the case, for example, of tenpura, when the oil undergoes discoloration, the color of the oil is ultimately taken into the batter and the tenpura finishes up with a poor appearance. In order to constantly provide a deep-fried food that has good flavor, texture, and appearance, it is therefore necessary to suppress the deterioration in the deep-frying fat.

In the sphere of deep-frying fats, there have been various attempts to produce a fat composition by the incorporation of an emulsifier in an edible fat; for example, the following have been proposed: 1) a fat composition for deep frying, prepared by the addition of an organic acid monoglyceride and a polyglycerol fatty acid ester; 2) a fat composition for deep frying provided by the addition of not more than 4.0% by weight of an emulsifier to a liquid fat; and 3) a fat composition for deep frying, provided by the addition of a fatty acid monoglyceride, a fatty acid diglyceride, and an organic acid monoglyceride and the extract of a spice (Patent Documents 1 to 3).

However, in the case of 1), the objects are to improve the coating appearance of the batter during deep frying and improve the food texture and to suppress oil spatter during cooking. While effects are certainly seen on these points, the organic acid monoglyceride incorporated in the fat composition emits a peculiar odor and produces an off odor during cooking and an impaired flavor by the deep-fried food.

In the case of 2), the object is again to improve the bubbling quality of the batter during deep frying and improve the food texture, and effects in this regard are manifested to a certain degree. However, with this deep-frying fat composition, the interfacial tension at 80° C. is required to be not more than 7 mN/m after 3 seconds, and due to this the emulsifier excessively accumulates around the interface and cannot be present uniformly in the fat as a whole and it would be difficult to say that the deterioration in the fat will be satisfactorily suppressed.

The object in the case of 3) is to maintain the flavor of the deep-fried food even during long-term use, and an effect is manifested due to the masking action of the spice, but within a limited range, e.g., the cooking of donuts with a hardened oil. However, in addition to the fact that the organic acid monoglyceride has a peculiar off-odor as noted above, the spice imparts a strong flavor even when used in small amounts, which compromises the versatility. Moreover, even if use as a fat with a specific flavor is possible for specific fried sweets, this causes an impaired flavor and hence is unsuitable—in the general case of tenpura and ready-to-eat meals such as fried foods.

A method has also been proposed for inhibiting discoloration and heating odor during the preparation of deep-fried foods; this method uses a fat composition that has specific property values, which are achieved by the addition of an emulsifier to an edible fat (Patent Document 4). This does significantly improve the properties of deep-frying fats and can inhibit fat deterioration at least during ordinary hot cooking. However, this method also has problems with substantially maintaining this effect at high temperatures, and temperature management is prone to be inadequate in the food processing industry and particularly at the actual site of production of ready-to-eat meals. In those instances where there is potential for long-term exposure of the deep-frying oil to high temperatures, the actual state of affairs is that this method is still only part way to being able to stably provide deep-fried food having both an excellent appearance and flavor.

A method has also been proposed in which the discoloration and heating odor of a deep-frying fat are suppressed by the addition of an emulsifier and a silicone; this method has the ability to maintain these effects on a long-term basis even at high temperatures (Patent Document 5). However, this method is unsuitable for fats for raw foods, e.g., mayonnaise and dressings.

Within the realm of stir-frying oils, stir-frying oils are commercially available that—through the addition of various emulsifiers, most prominently conventional lecithin—can efficiently transfer heat to the ingredients, can prevent heating from causing the food ingredients and seasonings to stick to the cookware, and can reinforce the stir-frying performance of the oil, e.g., the ability to impart full-bodied flavor to the food. The stir-frying performance evaluation of these oils has focused on the release properties, mainly the prevention of sticking, and little consideration has been given to reducing the amount of oil use. In recent years, however, there has been an increase in health-oriented consumers and a rise in the need to moderate oil intake. Moreover, providing a delicious flavor is a crucial aspect of oil performance, and the ability to produce tasty stir-fried food by stir-frying with scant oil is thus required of stir-frying oils.

As a consequence, with the object of improving the cooking performance, e.g., the taste, flavor, food texture, and so forth, a cooking fat composition has been proposed that contains a diglycerol monooleate ester (Patent Document 6). However, the cleaning effect for cookware post-use and for tableware post-contact with the cooked article is unsatisfactory. On the other hand, during the execution of stir frying, the area around the cookware is stained due to spattering by the oil during cooking, and the cook may also be burned as a result. A fat composition containing a specific glycerol fatty acid ester has been proposed (Patent Document 7) as a fat composition with the object of solving these problems. According to Patent Document 7, when used as a stir-frying oil, the quantity of use of this fat composition can be reduced to one-half or less that of a general-purpose oil, and this fat composition can also be used for deep frying. It is stated that an average HLB in the range of 5.6 to 15 is required and that functions such as preventing oil spattering and preventing oil absorption are not present at below this range (Patent Document 7). An edible fat that incorporates an emulsifier with such a high HLB is unsuitable for the preparation of mayonnaise due to inversion of the emulsified phase and the instability of emulsification. In addition, when used for deep frying, the incorporation of water is prone to occur and the oil will be cloudy after frying.
Patent Document 1: Japanese Patent Application Publication No. 9-74999 (JP-A-9-74999)
Patent Document 2: Japanese Patent Application Publication No. 7-16052 (JP-A-7-16052)
Patent Document 3: Japanese Patent Application Publication No. 6-113742 (JP-A-6-113742)
Patent Document 4: Japanese Patent Application Publication No. 2002-84970 (JP-A-2002-84970)
Patent Document 5: Japanese Patent Application Publication No. 2004-173614 (JP-A-2004-173614)
Patent Document 6: Japanese Patent Application Publication No. 8-131071 (JP-A-8-131071)
Patent Document 7: Japanese Patent Application Publication No. 2001-240894 (JP-A-2001-240894)

### Problem to be Solved by the Invention

Considering the problems noted above, i.e., that conventional fats that enable stir frying to be performed at a low quantity of use exhibit little versatility and must be limited to dedicated or restricted applications, the present invention seeks to provide a very versatile stir-frying oil that can also be used, for example, for deep frying and for the preparation of mayonnaise.

### Means for Solving the Problem

As a result of intensive investigations directed to solving the problems described above, the inventors discovered that an oil having the features listed above could be provided by the addition of 0.1 to 3% by weight of an emulsifier that has an HLB in a specific range. That is, the present invention is a fat composition provided by the addition to an edible oil of 0.1 to 3% by weight of an emulsifier that has an HLB of not more than 5. This HLB is calculated using the Griffin equation: HLB=20×(1−SV/NV) wherein SV is the saponification value of the ester and NV is the neutralization value of the fatty acid.

For example, a polyglycerol fatty acid ester can suitably be used as the emulsifier, but there is no limitation to this. A single emulsifier generally usable in food products may be used or a combination of such emulsifiers may be used, but an emulsifier that lowers the interfacial tension below 13 mN/m or that raises the surface tension is unsuitable. Furthermore, a sedimentation inhibitor is desirably added in order to prevent the stir frying-capable emulsifier from sedimenting. It has been discovered that polyglycerol polyricinoleate (PGPR) is particularly preferred for the sedimentation inhibitor, and that, only when the incorporation ratio between the emulsifier and PGPR is within a specific range, a very broad versatility can coexist with the ability to lower the quantity of use and an even better flavor can be brought out.

### Effects of the Invention

While the preparation of a dedicated oil in conformity to the application has heretofore been necessary, the present invention makes it possible to carry out stir frying, deep frying, and mayonnaise production with a single type of oil.

### BRIEF DESCRIPTION OF THE DRAWINGS

FIG. 1 compares the fat-coated area by image analysis with the quantity of fat addition and the type of fat.

FIG. 2 compares the surface gloss, stir-fry impression, and oiliness according to sensory evaluation with the quantity of fat addition and the type of fat.

### BEST MODES FOR CARRYING OUT THE INVENTION

The fat composition of the present invention is described herebelow. In this Specification, “stir fry” denotes, for example, the stir frying of dishes such as yakisoba, meat and green peppers, twice-cooked pork, happosai, Chinese-style fried rice, and so forth, as well as the usual meats, vegetables, and seafood, and also sautéing, yakiniku, potstickers, and other related dishes.

The emulsifier used by the present invention may be a food-grade emulsifier such as a polyglycerol fatty acid ester, sucrose fatty acid ester, sorbitan fatty acid ester, monoglyceride, and so forth, and must have an HLB of not more than 5 and more preferably has an HLB of not more than 4. The polyglycerol fatty acid esters have a preferred flavor and are particularly preferred for their significant ability to support a reduction in the amount of oil use.

There is no particular limitation on the fatty acid in the polyglycerol fatty acid ester, and this fatty acid can be exemplified by C₁₄₋₂₄ fatty acids, e.g., myristic acid, myristoleic acid, palmitic acid, palmitoleic acid, stearic acid, oleic acid, linoleic acid, linolenic acid, behenic acid, erucic acid, and so forth, wherein stearic acid and oleic acid, which are more resistant to oxidation than linoleic acid and linolenic acid, are preferred. In addition, the total amount of free glycerol and free polyglycerol in the polyglycerol fatty acid ester is desirably less than 1% by weight.

A single polyglycerol fatty acid ester may be used or a mixture of two or more may be used, and good effects are obtained even for use in combination with another emulsifier, for example, a monoglycerol fatty acid ester, sucrose fatty acid ester, sorbitan fatty acid ester, propylene glycol fatty acid ester, and so forth. An oxidation inhibitor, e.g., tocopherol, ascorbyl palmitate, rosemary extract, and so forth, may also be added.

The edible fat used by the present invention should be suitable for use in foods but is not otherwise particularly limited. Edible fats that are liquids at ambient temperature can be exemplified by soybean oil, rapeseed oil, corn oil, cottonseed oil, rice bran oil, safflower oil, sunflower oil, olive oil, and so forth; edible fats that are solids at ambient temperature can be exemplified by palm oil, beef tallow, lard, and so forth. The edible fat used by the present invention may also be, for example, a compound oil provided by mixing two or more of the previously indicated fats, a hardened oil provided by the hydrogenation of a fat, a fractionated oil as provided by fractionating a solid fat, and an oil provided by transesterification of a fat.

Examples are provided below, but the present invention is not limited by these examples.

### Example 1

### Preparation of Fat Compositions

Fat compositions A to G according to the present invention and comparative fat compositions A to F were prepared by adding an emulsifier as indicated below to rapeseed oil (J-Oil Mills, Inc.) (Table 1).

tetraglycerol pentaoleate (SY Glyster PO-3S from Sakamoto Yakuhin Kogyo Co., Ltd.)

decaglycerol decaoleate (SY Glyster DAO-7S from Sakamoto Yakuhin Kogyo Co., Ltd.)

hexaglycerol pentaoleate (SY Glyster PO-5S from Sakamoto Yakuhin Kogyo Co., Ltd.)

tetraglycerol monooleate (SY Glyster MO-3S from Sakamoto Yakuhin Kogyo Co., Ltd.)

hexaglycerol monooleate (SY Glyster MO-5S from Sakamoto Yakuhin Kogyo Co., Ltd.)

decaglycerol monooleate (SY Glyster MO-7S from Sakamoto Yakuhin Kogyo Co., Ltd.)

decaglycerol monocaprylate (SY Glyster MCA-750 from Sakamoto Yakuhin Kogyo Co., Ltd.)

soy lecithin (Lecithin AY from J-Oil Mills, Inc.)

TABLE 1

| | | | Quantity of emulsifier |
|---|---|---|---|
| Fat | | HLB of the | addition |
| composition | Type of emulsifier | emulsifier | (% by weight) |
| Example A | Tetraglycerol | 3 | 0.1 |
| Example B | pentaoleate | | 0.3 |
| Example C | | | 0.5 |
| Example D | | | 1.0 |
| Example E | | | 3.0 |
| Example F | Decaglycerol | 3.5 | 0.3 |
| | decaoleate | | |
| Example G | Hexaglycerol | 4.9 | 0.3 |
| | pentaoleate | | |
| Comparative | No addition | — | No addition |
| Example A | | | |
| Comparative | Tetraglycerol | 8.8 | 0.3 |
| Example B | monooleate | | |
| Comparative | Hexaglycerol | 11.6 | 0.3 |
| Example C | monooleate | | |
| Comparative | Decaglycerol | 12.9 | 0.3 |
| Example D | monooleate | | |
| Comparative | Decaglycerol | 16 | 0.3 |
| Example E | monocaprylate | | |
| Comparative | Soy lecithin | Unidentified | 3 |
| Example F | | | |

(Evaluation by Image Analysis)

The following evaluation procedure was set up in order to objectively evaluate the performance feature designated as the “ability to produce a delicious stir fry at small amounts” (image analysis procedure and description below).

1. The test oil was dyed with a food dye (zeaxanthin).
2. Cabbage was cut to 4 cm×1.5 cm pieces.
3. The dyed test oil was introduced into a frying pan that had been heated to a surface temperature of 200° C.; 150 g of the cabbage was then introduced; and stir frying was performed for 1 minute and 30 seconds.
4. The stir-fried cabbage was removed and cooled to room temperature and the state of the cabbage surface was then photographed using a digital microscope (Keyence Corporation).
5. The proportion of the colored region (region coated by the oil) in the field of the photograph was quantitated using image analysis software (Scion Image from the Scion Corporation) and converted into a numerical value.

Based on the literature, 10 g was used for the amount of the standard oil per 150 g cabbage in the stir fry step.

(Comparison of the Image Analysis Procedure and Sensory Evaluation)

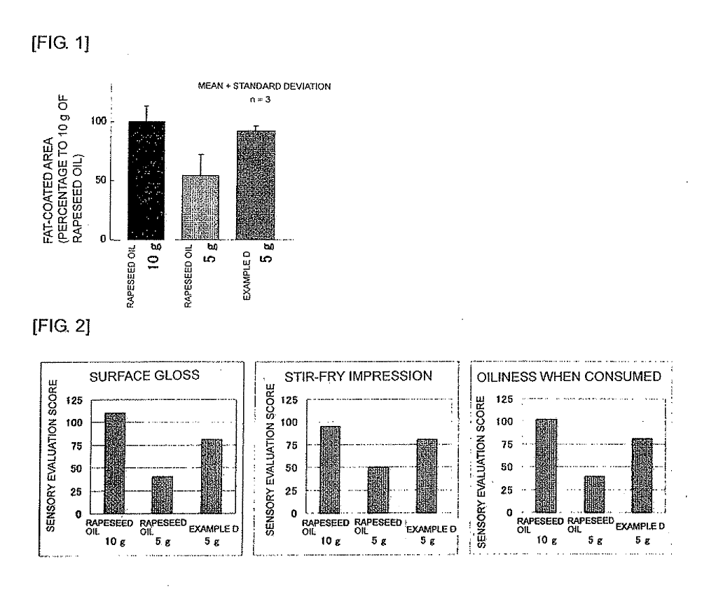

The validity of the image analysis procedure was verified by comparing the numerical results provided by image analysis for the stir-fried cabbage with evaluation results provided by sensory evaluation. The gloss of the stir-fried food, stir-fry impression (whether or not the food was cooked), and oiliness (was the flavor of the oil perceived?) were used for the items evaluated in the sensory evaluation. The results are shown in FIG. 1 and FIG. 2. According to these results, the evaluation results provided by image analysis and the evaluation results provided by sensory evaluation were generally the same, which thus demonstrated the validity of the image analysis procedure.

### (Ability to Reduce the Quantity of Use)

Using the image analysis procedure, the ability to reduce the quantity of use was compared for oil stir frying using Examples A to G and Comparative Examples A to F. The value determined when 150 g cabbage was stir fried with the control (10 g rapeseed oil) was used as 100%, and relative values were then calculated from the values determined for stir frying using 5 g of the fat compositions according to the examples and comparative examples. The relative values for the fat compositions according to the examples and comparative examples were scored as follows: a score of “A” was rendered for greater than or equal to 90%; a score of “B” was rendered for at least 85% but less than 90%; a score of “C” was rendered for at least 75% but less than 85%; and a score of “D” was rendered for less than 75%. The results are given in Table 2.

(Measurement of the Dynamic Interfacial Tension)

To obtain the dynamic interfacial tension of the fat compositions of the examples and comparative examples, the interfacial tension was measured 3 seconds after interface formation between water and the fat composition at 80° C. using a Lauda TVT-1 Automatic Drop Volume Tensiometer (Lauda); the results are shown in Table 2.

(Measurement of the Surface Tension)

The surface tension of the fat composition was measured using a CBVP-Z instrument from Kyowa Interface Science Co., Ltd., and a platinum plate; the results are shown in Table 2.

TABLE 2

| | | Results of the | Dynamic | |
|---|---|---|---|---|
| | | evaluation | interfacial | Surface |
| | HLB of the | of the stir-frying | tension | tension |
| Fat composition | emulsifier | performance | (mN/m) | (mN/m) |
| Example A | 3 | B | 34.3 | 28.3 |
| Example B | | A | 32.7 | 27.9 |
| Example C | | A | 31.4 | 27.2 |
| Example D | | A | 29.4 | 24.5 |
| Example E | | A | 24.3 | n.t. |
| Example F | 3.5 | B | n.t. | n.t. |
| Example G | 4.9 | B | 15.5 | 28.8 |
| Comparative | No addition | D | 35.2 | 28.4 |
| Example A | | | | |
| Comparative | 8.8 | C | 5.6 | 30.5 |
| Example B | | | | |
| Comparative | 11.6 | C | <5 | n.t. |
| Example C | | | | |
| Comparative | 12.9 | D | n.t. | 31.8 |
| Example D | | | | |
| Comparative | 16 | D | n.t. | n.t. |
| Example E | | | | |
| Comparative | — | A | n.t. | n.t. |
| Example F | | | | |

n.t.: the measurement was not performed

The results in Table 2 demonstrate that a delicious stir fry can be prepared at a small quantity of use when an emulsifier having an HLB no greater than 5 is added. The dynamic interfacial tension of the fat composition at this time was shown to be at least 13 mN/m and the surface tension was shown to be the same as or less than that of the edible fat prior to the addition of the emulsifier.

### Example 2

### Evaluation of the Versatility (Suitability for Deep Frying•Heating Odor)

400 g of the fat composition from Examples A to G and Comparative Examples A to F was placed in a stainless steel saucepan and was heated to 180° C. and a sensory evaluation was performed of the odor during heating. In addition, the suitability for deep frying was evaluated by frying commercially available frozen croquettes (Ajinomoto Frozen Foods Co., Inc.) using these fat compositions and visually inspecting for foaming; the results are shown in Table 3. The heating odor was evaluated using the following four levels: “A”: no off-odor (same as rapeseed oil), “B”: scarce off-odor, “C”: off-odor is present, “D”: substantial off-odor. The suitability for deep frying was evaluated using the following four levels: “A”: suitable (same as rapeseed oil), “B”: slight foaming is present, “C”: continuous foaming (not suitable for deep frying), “D”: substantial foaming (not usable for deep frying).

TABLE 3
Results of the evaluation of versatility

| Fat composition | Suitability for deep frying | Heating odor |
|---|---|---|
| Example A | A | A |
| Example B | A | A |
| Example C | A | A |
| Example D | A | B |
| Example E | B | B |
| Example F | A | A |
| Example G | A | A |
| Comparative Example A | A | A |
| Comparative Example B | A | A |
| Comparative Example C | B | C |
| Comparative Example D | B | C |
| Comparative Example E | B | D |
| Comparative Example F | D | C |

The fat compositions according to the present invention were all capable of deep frying and were also equivalent to Comparative Example A (only rapeseed oil) with regard to heating odor and were thus well qualified for deep frying applications.

### Example 3

### Evaluation of the Flavor and Suitability for Mayonnaise Production

Flavor evaluations were carried out by preparing the fat compositions of Examples A to G and Comparative Examples A to F and performing a sensory evaluation of the oil flavor. The evaluation was performed using the following four levels: “A”: no off-flavor/off-odor, “B”: slight off-flavor/off-odor, “C”: off-flavor/off-odor is present, “D′”: off-flavor/off-odor present to a degree that precludes food use.

The suitability for mayonnaise production was performed by preparing mayonnaise using the following recipe: 1 egg yolk, 2 tablespoons vinegar, and one-half teaspoon salt in 200 g of a fat composition as described above. The results of the evaluation are given as follows: “A”: very suitable for mayonnaise, “B”: suitable for mayonnaise, “C”: somewhat unsuitable for mayonnaise, “D”: problematic mayonnaise production.

TABLE 4

| | | Suitability for mayonnaise |
|---|---|---|
| Fat composition | Flavor | production |
| Example A | A | A |
| Example B | A | A |
| Example C | A | A |
| Example D | A | A |
| Example E | A | A |
| Example F | A | n.t. |
| Example G | A | n.t. |
| Comparative Example A | A | A |
| Comparative Example B | A | n.t. |
| Comparative Example C | A | n.t. |
| Comparative Example D | A | n.t. |
| Comparative Example E | D | n.t. |
| Comparative Example F | C | n.t. |

n.t.: the measurement was not performed

The fat compositions according to the present invention all had good flavor as a raw food and were shown to be very suitable for mayonnaise production.

### Example 4

### Ratio Between the Polyglycerol Fatty Acid Ester and PGPR

Fat compositions were prepared (Examples B and H to M) were prepared by adding 0 to 0.3% by weight PGPR (SY Glyster CR-ED from Sakamoto Yakuhin Kogyo Co., Ltd.) and 0.3% by weight tetraglycerol pentaoleate to rapeseed oil, and the stir-frying performance was evaluated by the method described in Example 1. The suitability for deep frying was also evaluated by the method described in Example 2. The fat compositions were also placed in beakers and were stored uncovered in a 40′C/90% RH ambient and the appearance of cloudiness•sedimentation caused by the emulsifier was monitored for 2 weeks in order to evaluate the storage stability. The results of the evaluation are given using the following four levels: “A”: no cloudiness sedimentation, “B”: slight decline in transparency, “C”: cloudiness is present, “D”: sedimentation is present. Mayonnaise was prepared by the method described in Example 3 and the production suitability was evaluated. All of the results are given in Table 5,

TABLE 5

| | | Results | | | |
|---|---|---|---|---|---|
| | | of the | | | |
| | PGPR | evaluation | | | Suitability |
| | addition | of the | Suitability | | for |
| Fat | (% by | stir-frying | for deep | Storage | mayonnaise |
| composition | weight) | performance | frying | stability | production |
| Example B | 0 | A | A | D | A |
| Example H | 0.005 | A | A | C | A |
| Example I | 0.01 | A | A | A | A |
| Example J | 0.02 | A | A | A | A |
| Example K | 0.05 | n.t. | A | A | B |
| Example L | 0.1 | A | A | A | D |
| Example M | 0.3 | B | A | A | D |

n.t.: the measurement was not performed

Based on Table 5, the fat compositions provided by the addition of PGPR at from at least 1/30 to less than ⅓ as the weight ratio to the emulsifier, preferably from at least 1/30 up to and including ⅙ as the weight ratio to the emulsifier, and more preferably at least 1/30 up to and including 1/15 as the weight ratio to the emulsifier, were suitable for the preparation of a delicious stir fry using scant oil and could be used for deep frying and were equipped with both a high storage stability and a very broad versatility that even made possible mayonnaise production.

### Example 5

### Comparison of Oil Species

Fat compositions were prepared by the addition of 0.3% by weight tetraglycerol pentaoleate and 0.01% by weight PGPR to rapeseed oil (Example I), soybean oil (Example N), and palm olein (Example O) (all the oils were from J-Oil Mills, Inc.) and were evaluated for their stir-frying performance using the method described in Example 1. The suitability for deep frying was also evaluated according to the method described in Example 2. The results are given in Table 6.

TABLE 6

| | Results of the evaluation | |
|---|---|---|
| Fat | of the stir-frying | Suitability for deep |
| composition | performance | frying |
| Example I | A | A |
| Example N | A | A |
| Example O | A | A |

1. A fat composition obtained by adding, to an edible fat, 0.1 to 3% by weight of an emulsifier having an HLB of not more than 5.

2. The fat composition according to claim 1, wherein the emulsifier is a polyglycerol fatty acid ester.

3. The fat composition according to claim 1, obtained by adding, to the emulsifier, a polyglycerol polyricinoleate at from at least 1/30 to less than ⅓ as the weight ratio.

4. The fat composition according to claim 2, obtained by adding, to the emulsifier, a polyglycerol polyricinoleate at from at least 1/30 to less than ⅓ as the weight ratio.
